(19) United States
(12) Patent Application Publication
(10) Pub. No.: US 2026/0356181 A1
(43) Pub. Date: Nov. 12, 2026

(54) MOTOR VEHICLE WITH A HIGH-VOLTAGE BATTERY

(71) Applicant: MAGNA STEYR Fahrzeugtechnik GmbH & Co KG, Graz (AT)

(72) Inventors: Bernhard HOFER, Graz (AT); Karin SACKL, Vasoldsberg (AT)

(73) Assignee: MAGNA STEYR Fahrzeugtechnik GmbH & Co KG, Graz (AT)

(21) Appl. No.: 19/645,509

(22) Filed: Apr. 13, 2026

(30) Foreign Application Priority Data
May 7, 2025 (EP) 25174710.1

(51) Int. Cl. B60K 1/04; B60L 58/26; B60R 16/02; B62D 25/20; B62D 25/24; H01M 50/249

(52) U.S. Cl. CPC B60K 1/04; B60L 58/26; B60R 16/0215; B62D 25/20; B62D 25/24; H01M 50/249; B60K 2001/0438; H01M 2220/20

(57) ABSTRACT

A motor vehicle that includes a floor structure; a footwell area configured to support feet of vehicle passengers; a high-voltage battery arranged underneath the floor structure over a predefined footwell area, the high-voltage battery including an electrical network, a battery housing, and battery modules electrically connected to the electrical network in the battery housing, the battery module are not arranged in the battery housing at the predefined footwell area; a boundary wall arranged over the battery housing in the predefined footwell area, the boundary wall having a first indentation oriented downwardly to define a holding bay on an upper side of the boundary wall at the top of the battery housing; and at least one electrical connector arranged on the holding bay and configured for electrical connection to the electrical network to accommodate an additional battery module in the holding bay for electrical connection to the electrical network.

### CROSS-REFERENCE TO RELATED APPLICATIONS

The present application claims priority under 35 U.S.C. § 119 to European Patent Publication No. 25174710.1 (filed on May 7, 2025), which is hereby incorporated by reference in its complete entirety.

### TECHNICAL FIELD

The present disclosure relates to a motor vehicle having a high-voltage battery and to a method for converting such a motor vehicle.

### BACKGROUND

It is known that motor vehicles can use a high-voltage battery as a drive battery, for example in electric or hybrid vehicles. In order to achieve the highest possible range of the motor vehicle, high-voltage batteries with the greatest possible capacity are needed; however, the installation space needed should be as small as possible. High-voltage batteries are therefore formed as flat storage devices, for example, and are arranged in a space-saving manner underneath a vehicle floor in a motor vehicle.

Battery-electrically operated vehicles which carry their battery under the vehicle floor in some cases have foot spaces for the rear-seat passengers, i.e. depressions in the vehicle floor which are designed for passengers on seats in the vehicle to place their feet, in order to configure the sitting position as ergonomically as possible and to keep the vehicle height low. As a result of the depression of the vehicle floor in the area of the foot space, no battery cells can be accommodated at this point, since the installation space therefor is not provided, whereby the capacity of the battery and a range of the motor vehicle are restricted.

### SUMMARY

It is an object of the present disclosure to specify a motor vehicle having a high-voltage battery, wherein the motor vehicle can be adapted flexibly to a customer's need for a high range of the motor vehicle and/or an increased battery capacity or improved ergonomics for vehicle passengers.

A further object is to specify a method for converting such a motor vehicle in order to be able to adapt the motor vehicle simply and flexibly to a customer's need for a high range of the motor vehicle and/or an increased battery capacity or improved ergonomics for vehicle passengers.

The object is achieved by a motor vehicle having a high-voltage battery arranged underneath a floor structure of the motor vehicle. The high-voltage battery comprises battery modules in a battery housing, the battery modules being electrically connected to an electrical network of the high-voltage battery via electrical connectors. In a plan view of the motor vehicle, the high-voltage battery extends over a predefined footwell area of the motor vehicle, which is provided for vehicle passengers to place their feet. No battery module is arranged in the battery housing in the predefined footwell area. A boundary wall located at the top of the battery housing in the predefined footwell area has an indentation downwards to form a holding bay on the upper side of the boundary wall located at the top of the battery housing. At least one electrical connector is formed on the holding bay, which is electrically connected to the electrical network of the high-voltage battery and/or a further electric circuit in the motor vehicle, so that an additional battery module can optionally be accommodated in the holding bay and is electrically connected to the electrical network of the high-voltage battery and/or a further electric circuit of the motor vehicle via the electric connector. Alternatively, the holding bay can be used as a foot space in the predefined footwell area of the motor vehicle.

In accordance with the present disclosure, in a motor vehicle having a flat or planar high-voltage battery underneath a floor group of the motor vehicle in an area extending in the x-y plane which is provided for the feet of a passenger of the motor vehicle to be placed, no battery module is arranged in the battery housing in this selected area, as opposed to other areas of the high-voltage battery. Instead, in the battery housing, a holding bay is formed in the boundary wall located at the top of the battery housing, so that there is a free space on the upper side of the high-voltage battery. This free space can then be used optionally as a foot space, i.e., as a lowered area for increased freedom for the legs of a passenger. Alternatively, a battery module can be placed at this point, thus, outside the battery housing, and wired to the electrical system of the remaining battery modules and/or another circuit in the motor vehicle via an electrical connector already provided for the purpose. Advantageously, a connection to a cooling system of the high-voltage battery is likewise already provided. The battery module or modules located on the outside, i.e., the additional battery module or modules in the holding bay, thus form a retrospectively extended battery module of the same high-voltage battery and increase its capacity or provide capacity for a further circuit. The installation of an additional battery module and the removal of an additional battery module can be carried out at any time after purchase, for example simply in a workshop, since the motor vehicle is prepared for the conversion.

The present disclosure thus offers the customer the possibility of being able to decide on a higher battery capacity following the purchase of the vehicle. Thus, retrospective adaptation in accordance with the use or the customer's request can be carried out. Retrospective adaptation of the motor vehicle to changing customer needs, by means of installing an additional battery pack instead of a foot space, in particular for rear-seat passengers, or vice versa is possible.

The optional additional battery module can, for example, be electrically connected to a further circuit in the vehicle, in particular form an expansion of capacity for the further circuit. The other circuit can, for example, be a 12V, 24V, or 48V vehicle electrical system or a voltage supply for camping purposes. The additional battery module can then not be electrically connected or not be directly electrically connected to the high-voltage battery. The additional battery module can be available, for example, as an expansion of storage for the drive energy but not be in direct contact with the high-voltage battery via the electrical connector, instead provide energy directly to power electronics for the purpose of the drive. Hereby, for example in the event of a defect in the drive battery, an independent, alternative drive battery system is available.

Developments of the present disclosure are indicated in the dependent claims, the description and the appended drawings.

The battery modules are preferably connected to a cooling system for cooling the battery modules, wherein at least one cooling connector, which is connected to the cooling system of the high-voltage battery, is formed on the holding bay, so that an additional battery module optionally accommodated in the holding bay is connected to the cooling system of the high-voltage battery via the cooling connector. The cooling system can, for example, use a cooling fluid for cooling the battery modules. The cooling fluid can then flow into the additional battery module at the prepared cooling connector in the holding bay.

The floor structure of the motor vehicle preferably has a removable structural floor component in the area of the holding bay, wherein the removable structural floor component preferably has an indentation downwards, so that the structural floor component is substantially matched to the holding bay of the high-voltage battery, i.e. reaches into the holding bay and thus likewise forms a holding bay on its outer side located at the top, so that the holding bay can be used as a foot space in the area above the removable structural floor component.

The removable structural floor component is preferably fastened in a sealed and detachable manner to the remaining floor structure of the motor vehicle by means of a seal and by means of fastening elements, for example screws.

The additional battery module can itself form the floor structure of the motor vehicle in the area of the holding bay on its upper side, so that the additional battery module replaces the removable structural floor component. An additional covering above the additional battery module is then not required. The upper side of the additional battery module can then be fastened to the remaining floor structure, preferably in a sealed manner.

The floor structure of the motor vehicle preferably has a removable structural floor cover component in the area of the holding bay when the additional battery module is inserted into the holding bay, wherein the structural floor cover component has no substantial indentation downwards but is substantially flat, wherein the structural floor cover component covers the additional battery module at the top. The structural floor cover component can therefore be used as a delimitation of the additional battery module from the vehicle interior, as a replacement for the removable structural floor component when an additional battery module is accommodated in the holding bay. The structural floor cover component is considerably flatter than the removable structural floor component.

The predefined footwell area of the motor vehicle is preferably at least a sub-area of the footwell for rear-seat passengers of the motor-vehicle.

The additional battery module which can optionally be accommodated in the holding bay preferably has approximately the same size as the battery modules in the battery housing. The holding bay preferably has a height of more than 50% of the height of the battery housing in the area of the battery modules, preferably more than 80% of the height of the battery housing in the area of the battery modules.

The holding bay can be designed such that at least two additional battery modules can be accommodated, lying beside one another in the holding bay in the motor-vehicle transverse direction. The at least two additional battery modules can, for example, be arranged in a common additional battery module housing and/or can use the same electrical connector and/or the same cooling connector in the holding bay. Alternatively, at least two electrical connectors and preferably at least two cooling connectors can be formed in the holding bay, so that at least two additional battery modules in the holding bay can each be electrically connected to the electrical network of the high-voltage battery, preferably can also each be connected to the cooling system of the high-voltage battery.

A method in accordance with the present disclosure for converting a motor vehicle as described previously can provide that the removable structural floor component is removed from the remaining floor structure, that the additional battery module is then inserted into the holding bay, that before, during or after the insertion of the additional battery module into the holding bay, the additional battery module is electrically connected to the electrical connector and thus electrically connected to the electrical network of the high-voltage battery, wherein preferably before, during or after the insertion of the additional battery module into the holding bay, the additional battery module is connected to the cooling connector and thus connected to the cooling system of the high-voltage battery. The connection to the electrical connector and/or to the cooling connector can, for example, be carried out automatically by the insertion of the additional battery module into the holding bay. Optionally, following the insertion and the production of the connections to the connectors, a structural floor cover component can be arranged above the additional battery module as a cover and preferably be mechanically connected to the remaining floor structure, preferably connected in a sealed manner.

### DRAWINGS

The present disclosure is described below by way of example with reference to the drawings.

FIG. 1 illustrates a schematic sectional view of a motor vehicle in an area of the high-voltage battery, in a state in which the holding bay is used as a foot space, in accordance with the present disclosure.

FIG. 2 illustrates a schematic sectional view of the motor vehicle of FIG. 1, in a state in which the holding bay is used to hold an additional battery module.

FIG. 3 illustrates a schematic sectional view of the additional battery module of the motor vehicle of FIG. 2.

### DESCRIPTION

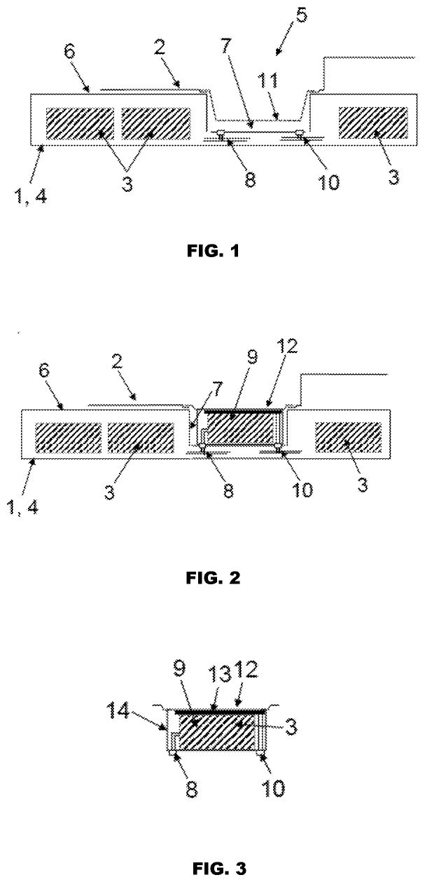

A motor vehicle in accordance with the present disclosure is illustrated in FIG. 1 in the area of the high-voltage battery 1 in a state in which a holding bay 7 of the high-voltage battery 1 is used as a foot space. The same motor vehicle is illustrated in FIG. 2 in a state in which the holding bay 7 of the high-voltage battery 1 is used to hold an additional battery module 9.

The high-voltage battery 1 is arranged underneath a floor structure 2 of the motor vehicle and comprises a plurality of battery modules 3 in a battery housing 4, each having a large number of battery cells. It is possible for a plurality of battery modules 3 to be arranged one after another in the vehicle longitudinal direction and beside one another in the vehicle transverse direction. The battery modules 3 are electrically connected to an electrical network of the high-voltage battery 1 via electric connectors, so that a common external electrical connection of the high-voltage battery from the electrical network of the high-voltage battery is provided. In a plan view of the motor vehicle, the high-voltage battery 1 extends over a predefined footwell area 5 of the motor vehicle, which is provided for vehicle passengers to place their feet, in particular in the general area of the footwell of rear-seat passengers.

No battery module is arranged in the battery housing 4 in this predefined footwell area 5, wherein a boundary wall 6 of the battery housing 4 located at the top in the predefined footwell area 5 has an indentation downwards to form a holding bay 7 on the upper side of the boundary wall 6 located at the top of the battery housing 4, and thus to “hold” an object on the outside of the high-voltage battery 1.

An electrical connector 8 is formed on the holding bay 7, which is electrically connected to the electrical network of the high-voltage battery 1, so optionally, as illustrated in FIG. 2, an additional battery module 9 can be accommodated in the holding bay 7 and electrically connected to the electrical network of the high-voltage battery 1 via the electrical connector 8. When no additional battery module 9 is accommodated in the holding bay 7, the holding bay 7, as illustrated in FIG. 1, can be used as a foot space in the predefined footwell area 5 of the motor vehicle.

The battery modules 3 can also be connected to a cooling system for cooling the battery modules 3, and a cooling connector 10, which is connected to the cooling system of the high voltage battery 1, can be formed on the holding bay 7, so that an additional battery module 9 optionally accommodated in the holding bay 7 is connected to the cooling system of the high-voltage battery 1 via the cooling connector 10.

An additional battery module 9 accommodated in a holding bay 7 is illustrated in FIG. 3. The additional battery module 9 uses a plate-like heat sink 13 which, for example, cools the battery cells of the additional battery module 9 via a cooling fluid which can flow into the additional battery module 9 at the cooling connector 10.

The floor structure 2 of the motor vehicle has a removable structural floor component 11 in the area of the holding bay 7, wherein the removable structural floor component 11 has an indentation downwards, so that the shape of the structural floor component 11 is substantially matched to the holding bay 7 of the high-voltage battery 1, with the result that the holding bay 7 in the area above the removable structural floor component 11 can be used as a foot space.

The removable structural floor component 11 is fastened to the remaining floor structure 2 of the motor vehicle in a sealed and detachable manner by means of a seal and by means of fastening elements, for example screws.

As can be seen in FIG. 2, the floor structure 2 of the motor vehicle has a removable structural floor cover component 12 in the area of the holding bay 7 when there is an additional battery module 9 inserted into the holding bay 7, wherein the structural floor cover component 12 has no substantial indentation downwards, so that the structural floor cover component 12 covers the additional battery module 9 at the top in the manner of a cover. The upper side of the structural floor cover component 12 can then be used for passengers of the motor vehicle to place their feet but does not form any foot space shaped essentially downwards.

The additional battery module 9, which can optionally be accommodated in the holding bay 7, has approximately the same size as the battery modules 3 in the battery housing 4. The holding bay 7 has a height of more than 70% of the height of the battery housing 4 in the area of the battery modules 3.

It is possible for a plurality of additional battery modules 9 to be accommodated in the holding bay 7. The plurality of additional battery modules 9 can, for example, be arranged in a common housing 14 and can share the same electrical connector 8 and/or cooling connector 10 or each use individual electrical connectors 8 and/or cooling connectors 10.

In a battery-electrically operated vehicle which carries a battery under the vehicle floor, a foot space for the rear-seat passengers can thus optionally be formed in order to configure the seating position ergonomically and to keep the vehicle height low. Then no battery cells are accommodated at this point, since the installation space for this is not provided, and the restricted capacity of the battery is accepted. The present disclosure offers the customer the possibility of being able to decide on a higher battery capacity following the purchase of the vehicle, the less pleasant seating position for the rear-seat passengers then being accepted. Thus, retrospective adaptation in accordance with the use or the customer's request can then be carried out. The present disclosure thus includes a battery pack which can be retrospectively installed, preferably in a specialist workshop, and the prepared connectors such as electrical connectors and an attachment to the battery cooling system. These interfaces are already implemented when the vehicle is delivered and are activated and used when an additional battery module is installed. The foot space at the basic equipment level is converted by means of a removable structural floor component 11, in particular an assembly part, which is inserted into the vehicle floor in a sealed manner and is re-detachable, for example by using a seal and a screw fixing. If necessary, the removable structural floor component 11 is removed and a battery module is inserted into the recess, the housing 14 of which can also form the vehicle floor in the recess. The connectors can preferably be contacted automatically during the insertion. Alternatively, the connectors are preferably connected before the insertion, which is preferably made possible by a suitable extra length of the leads. In another alternative, the battery module is inserted and the connection of the leads is then produced. The insertion of a separate cover, i.e. a structural floor cover component 12, into the recess or into the holding bay 7 on the vehicle floor is preferably then carried out.

### LIST OF REFERENCE SYMBOLS

1 High-voltage battery
2 Floor structure
3 Battery modules
4 Battery housing
5 Footwell area
6 Boundary wall located at the top
7 Holding bay
8 Electric connector
9 Additional battery module
10 Cooling connector
11 Removable structural floor component
12 Structural floor cover component
13 Heat sink
14 Housing of the additional battery module

What is claimed is:

1. A motor vehicle, comprising:
a floor structure;
a footwell area configured to support feet of vehicle passengers;
a high-voltage battery arranged underneath the floor structure to extend over a predefined footwell area, the high-voltage battery including an electrical network, a battery housing, and a plurality of battery modules electrically connected to the electrical network in the battery housing, wherein the battery module are not arranged in the battery housing at the predefined footwell area;
a boundary wall arranged over the battery housing in the predefined footwell area, the boundary wall having a first indentation oriented downwardly to define a holding bay on an upper side of the boundary wall at the top of the battery housing; and
at least one electrical connector arranged on the holding bay and configured for electrical connection to the electrical network to accommodate an additional battery module in the holding bay for electrical connection to the electrical network.

2. The motor vehicle of claim 1, further comprising at least one cooling connector configured to fluidically connect the battery modules to a battery cooling system configured to cool the battery modules.

3. The motor vehicle of claim 1, wherein the floor structure comprises a removable structural floor component adjacent to the holding bay.

4. The motor vehicle of claim 3, wherein the removable structural floor component has a second indentation oriented downwardly to correspond to the first indentation so that a shape of the removable structural floor component substantially corresponds to a shape of the holding bay.

5. The motor vehicle of claim 4, wherein the removable structural floor component is fastened to the remaining floor structure in a sealed and detachable manner.

6. The motor vehicle of claim 4, wherein the additional battery module forms the floor structure in the area of the holding bay so that the additional battery module replaces the removable structural floor component.

7. The motor vehicle of claim 4, wherein the floor structure comprises a removable structural floor cover component adjacent to the holding bay when the additional battery module is inserted into the holding bay.

8. The motor vehicle of claim 7, wherein the structural floor cover component is substantially planar.

9. The motor vehicle of claim 8, wherein the structural floor cover component covers a top region of the additional battery module.

10. The motor vehicle of claim 1, wherein the predefined footwell area comprises at least a sub-area of the footwell for rear-seat passengers of the motor vehicle.

11. The motor vehicle of claim 1, wherein the additional battery module has a size that substantially corresponds to a size of the battery modules.

12. The motor vehicle of claim 1, wherein the holding bay has a height of greater than 50% of the height of the battery housing.

13. The motor vehicle of claim 1, wherein the holding bay is configured to accommodate at least two additional battery modules oriented in a traverse direction of the motor vehicle.

14. The motor vehicle of claim 1, wherein at least one electrical connector is configured for electrical connection to an electric circuit of the motor vehicle.

15. The motor vehicle of claim 1, wherein the holding bay is configured as a foot space in the predefined footwell area.

16. A method converting the motor vehicle of claim 1 to another configuration, the method comprising:
removing the removable structural floor component from the floor structure;
inserting the additional battery module into the holding bay, wherein the additional battery module is electrically connected to the electrical connector and the electrical network of the high-voltage battery, and wherein the additional battery module is connected to the cooling connector and thus the battery cooling system.
